(19) United States
(12) Patent Application Publication
(10) Pub. No.: US 2024/0194008 A1
(43) Pub. Date: Jun. 13, 2024

(54) MULTI-VEHICLE FOB

(71) Applicant: Clark McLane, Lufkin, TX (US)

(72) Inventor: Clark McLane, Lufkin, TX (US)

(21) Appl. No.: 18/077,573

(22) Filed: Dec. 8, 2022

(51) Int. Cl. G07C 9/00

(52) U.S. Cl. CPC G07C 9/00309; G07C 2009/00507

(57) ABSTRACT

A multi-vehicle fob, including a main body, a plurality of vehicle select buttons disposed on at least a portion of the main body, each of the plurality of vehicle select buttons to select at least one vehicle in response to being depressed, and a vehicle power button disposed on at least a portion of the main body to turn on the at least one vehicle in response to being depressed a first time based on which vehicle is currently selected, and turn off the at least one vehicle in response to being depressed a second time.

### BACKGROUND

### 1. Field

The present general inventive concept relates generally to a vehicle fob, and particularly, to a multi-vehicle fob.

### 2. Description of the Related Art

Some people own and/or drive more than one vehicle. In order to use, each vehicle, a driver will need to have a fob and/or a key. Thus, for the driver who needs to drive multiple vehicles, multiple fobs and/or keys will need to be carried.

However, carrying and/or sorting through multiple fobs can be incredibly inconvenient and troublesome while trying to find a certain vehicle. Moreover, current fobs tend to be bulky and take up space.

Therefore, there is a need for a multi-vehicle fob that facilitates use of multiple vehicles.

### SUMMARY

The present general inventive concept provides a multi-vehicle fob.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a multi-vehicle fob, including a main body, a plurality of vehicle select buttons disposed on at least a portion of the main body, each of the plurality of vehicle select buttons to select at least one vehicle in response to being depressed, and a vehicle power button disposed on at least a portion of the main body to turn on the at least one vehicle in response to being depressed a first time based on which vehicle is currently selected, and turn off the at least one vehicle in response to being depressed a second time.

The vehicle power button may turn on an alarm of the at least one vehicle in response to being depressed a first time for a first predetermined period of time, and turns off the alarm of the at least one vehicle in response to being depressed a second time for a second predetermined period of time.

The multi-vehicle fob may further include a tailgate button disposed on at least a portion of the main body to open a tailgate of the at least one vehicle in response to being depressed a first time, and close the tailgate of the at least one vehicle in response to being depressed a second time.

The plurality of vehicle select buttons may be programmable to connect to the at least one vehicle by holding a key of the at least one vehicle within a predetermined distance of the main body and depressing at least one of the plurality of vehicle select buttons for a predetermined period of time.

The plurality of vehicle select buttons and the vehicle power button may be semi-spherical and protrude a distance above a surface of the main body to facilitate touching.

The plurality of vehicle select buttons and the vehicle power button may have textured indicia disposed thereon to identify at least one of a type of button and functionality.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric view of a multi-vehicle fob, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Multi-Vehicle Fob 100
Main Body 110
Vehicle Select Buttons 120
First Vehicle Button 121
Second Vehicle Button 122
Third Vehicle Button 123
Fourth Vehicle Button 124
Fifth Vehicle Button 125
Sixth Vehicle Button 126
Vehicle Power Button 130
Vehicle Locks Buttons 140
Unlock Button 141
Lock Button 142
Tailgate Button 150
Control Unit 160
Power Source 170
Keychain Aperture 180

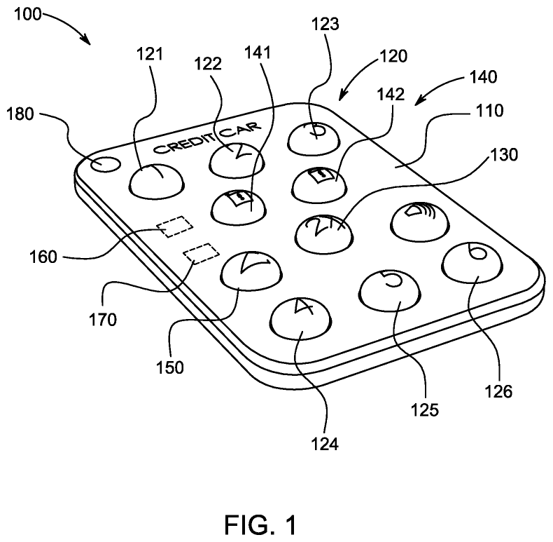

FIG. 1 illustrates an isometric view of a multi-vehicle fob 100, according to an exemplary embodiment of the present general inventive concept.

The multi-vehicle fob 100 may be constructed from at least one of metal, plastic, wood, glass, and rubber, etc., but is not limited thereto. Also, the multi-vehicle fob 100 may be weatherproof (e.g., rain, snow, sleet, heat, etc.).

The multi-vehicle fob 100 may include a main body 110, a plurality of vehicle select buttons 120, a vehicle power button 130, a plurality of vehicle locks buttons 140, a tailgate button 150, a control unit 160, a power source 170, and a keychain aperture 180, but is not limited thereto.

Referring to FIG. 1, the main body 110 is illustrated to have a rounded rectangular prism shape. However, the main body 110 may be rectangular, spherical, cylindrical, triangular, pentagonal, hexagonal, heptagonal, octagonal, or any other shape known to one of ordinary skill in the art, but is not limited thereto.

The main body 110 may have a predetermined size for portability. Moreover, the main body 110 may have a size (e.g., length, width) to fit in at least one pocket of clothing and/or a purse.

The plurality of vehicle select buttons 120 may include a first vehicle button 121, a second vehicle button 122, a third vehicle button 123, a fourth vehicle button 124, a fifth vehicle button 125, and a sixth vehicle button 126, but is not limited thereto.

The first vehicle button 121 may be disposed on at least a portion of the main body 110. The first vehicle button 121 may select a first vehicle in response to being depressed. Moreover, the first vehicle button 121 may be programmed to connect to the first vehicle by holding a first key and/or a first fob within a predetermined distance of the main body 110 and depressing the first vehicle button 121 for a first predetermined period of time (e.g., two seconds, five seconds).

The second vehicle button 122 may be disposed on at least a portion of the main body 110. The second vehicle button 122 may select a second vehicle in response to being depressed. Moreover, the second vehicle button 122 may be programmed to connect to the second vehicle by holding a second key and/or a second fob within a predetermined distance of the main body 110 and depressing the second vehicle button 122 for a second predetermined period of time (e.g., two seconds, five seconds).

The third vehicle button 123 may be disposed on at least a portion of the main body 110. The third vehicle button 123 may select a third vehicle in response to being depressed. Moreover, the third vehicle button 123 may be programmed to connect to the third vehicle by holding a third key and/or a third fob within a predetermined distance of the main body 110 and depressing the third vehicle button 123 for a third predetermined period of time (e.g., two seconds, five seconds).

The fourth vehicle button 124 may be disposed on at least a portion of the main body 110. The fourth vehicle button 124 may select a fourth vehicle in response to being depressed. Moreover, the fourth vehicle button 124 may be programmed to connect to the fourth vehicle by holding a fourth key and/or a fourth fob within a predetermined distance of the main body 110 and depressing the fourth vehicle button 124 for a fourth predetermined period of time (e.g., two seconds, five seconds).

The fifth vehicle button 125 may be disposed on at least a portion of the main body 110. The fifth vehicle button 125 may select a fifth vehicle in response to being depressed. Moreover, the fifth vehicle button 125 may be programmed to connect to the fifth vehicle by holding a fifth key and/or a fifth fob within a predetermined distance of the main body 110 and depressing the fifth vehicle button 125 for a fifth predetermined period of time (e.g., two seconds, five seconds).

The sixth vehicle button 126 may be disposed on at least a portion of the main body 110. The sixth vehicle button 126 may select a sixth vehicle in response to being depressed. Moreover, the sixth vehicle button 126 may be programmed to connect to the sixth vehicle by holding a sixth key and/or a sixth fob within a predetermined distance of the main body 110 and depressing the sixth vehicle button 126 for a sixth predetermined period of time (e.g., two seconds, five seconds).

It is important to note that although only six vehicles are described, additional buttons may be included to control more vehicles. Alternatively, less buttons may be included to control less vehicles.

The vehicle power button 130 may be disposed on at least a portion of the main body 110. The vehicle power button 130 may turn on the first vehicle, the second vehicle, the third vehicle, the fourth vehicle, the fifth vehicle, and/or the sixth vehicle in response to being depressed a first time based on which vehicle is currently selected. Additionally, the vehicle power button 130 may turn off the first vehicle, the second vehicle, the third vehicle, the fourth vehicle, the fifth vehicle, and/or the sixth vehicle in response to being depressed a second time.

Alternatively, and/or in addition thereto, the vehicle power button 130 may be an alert button. More specifically, the vehicle power button 130 may turn on an alarm (e.g., blow horn, siren) of the first vehicle, the second vehicle, the third vehicle, the fourth vehicle, the fifth vehicle, and/or the sixth vehicle in response to being depressed a first time for a first predetermined period of time (e.g., two seconds, five seconds) based on which vehicle is currently selected. Conversely, the vehicle power button 130 may turn off the alarm of the first vehicle, the second vehicle, the third vehicle, the fourth vehicle, the fifth vehicle, and/or the sixth vehicle in response to being depressed a second time for a second predetermined period of time (e.g., two seconds, five seconds).

The plurality of vehicle locks buttons 140 may include an unlock button 141 and a lock button 142, but is not limited thereto.

The unlock button 141 may be disposed on at least a portion of the main body 110. The unlock button 141 may unlock at least one door of the first vehicle, the second vehicle, the third vehicle, the fourth vehicle, the fifth vehicle, and/or the sixth vehicle in response to being depressed based on which vehicle is currently selected.

The lock button 142 may be disposed on at least a portion of the main body 110. The lock button 142 may lock the at least one door of the first vehicle, the second vehicle, the third vehicle, the fourth vehicle, the fifth vehicle, and/or the sixth vehicle in response to being depressed based on which vehicle is currently selected.

The tailgate button 150 may be disposed on at least a portion of the main body 110. The tailgate button 150 may open a tailgate of the first vehicle, the second vehicle, the third vehicle, the fourth vehicle, the fifth vehicle, and/or the sixth vehicle in response to being depressed a first time based on which vehicle is currently selected. Conversely, the tailgate button 150 may close the tailgate of the first vehicle, the second vehicle, the third vehicle, the fourth vehicle, the fifth vehicle, and/or the sixth vehicle in response to being depressed a second time.

The control unit 160 may include a processing unit, a communication unit, and a storage unit, but is not limited thereto.

The processing unit of the control unit 160 (or central processing unit, CPU) may include electronic circuitry to carry out instructions of a computer program by performing basic arithmetic, logical, control and input/output (I/O) operations specified by the instructions. The processing unit of the control unit 160 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit of the control unit 160 may also include a microprocessor and a microcontroller.

The communication unit of the control unit 160 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit of the control unit 160 may include a random access memory (RAM), a read-only memory (ROM), a hard disk, a flash drive, a database connected to the Internet, cloud-based storage, Internet-based storage, or any other type of storage unit.

The control unit 160 may be disposed within at least a portion of the main body 110. The control unit 160 may have a program (e.g., a software application) running thereon to determine functionality of each of the buttons on the main body 110. Moreover, the control unit 160 executing the program may allow each of the plurality of vehicle select buttons 120 to connect to and/or be associated with the first vehicle, the second vehicle, the third vehicle, the fourth vehicle, the fifth vehicle, and/or the sixth vehicle. In other words, the control unit 160 may facilitate programming of functionality of the buttons on the main body 110 based on at least one vehicle.

For example, the control unit 160 executing the program may allow the vehicle power button 130, the plurality of vehicle locks buttons 140, and/or the tailgate button 150 to control each of the aforementioned functions described above with respect to each button.

Furthermore, the plurality of vehicle select buttons 120, the vehicle power button 130, the plurality of vehicle locks buttons 140, and/or the tailgate button 150 may be semi-spherical for comfort and protrude a distance above a surface of the main body 110 to facilitate touching by a user. Also, each of the plurality of vehicle select buttons 120, the vehicle power button 130, each of the plurality of vehicle locks buttons 140, and/or the tailgate button 150 may have a textured indicia disposed thereon to identify a type of the button and/or functionality. In other words, the user may identify a function of the button based on touch and/or texture on each button without looking.

The power source 170 may include a battery and a solar cell, but is not limited thereto.

The power source 170 may be disposed within at least a portion of the main body 110. The power source 170 may provide power to the plurality of vehicle select buttons 120, the vehicle power button 130, the plurality of vehicle locks buttons 140, the tailgate button 150, and/or the control unit 160.

Furthermore, the power source 170 may be charged (e.g., a rechargeable battery) in response to connecting to an external power source (e.g., a power outlet, an inductive charger, a wireless charger, etc.).

The keychain aperture 180 may be disposed on and/or within at least a portion of the main body 110. The keychain aperture 180 may receive at least a portion of a keychain therethrough. As such, the main body 110 may be held via the keychain.

Therefore, the multi-vehicle fob 100 may enable control of multiple vehicles without having to carry keys and/or fobs for each vehicle. Also, the multi-vehicle fob 100 may reduce space required to operate each vehicle by having a smaller size than a conventional key and/or fob.

The present general inventive concept may include a multi-vehicle fob 100, including a main body 110, a plurality of vehicle select buttons 120 disposed on at least a portion of the main body 110, each of the plurality of vehicle select buttons 120 to select at least one vehicle in response to being depressed, and a vehicle power button 130 disposed on at least a portion of the main body 110 to turn on the at least one vehicle in response to being depressed a first time based on which vehicle is currently selected, and turn off the at least one vehicle in response to being depressed a second time.

The vehicle power button 130 may turn on an alarm of the at least one vehicle in response to being depressed a first time for a first predetermined period of time, and turns off the alarm of the at least one vehicle in response to being depressed a second time for a second predetermined period of time.

The multi-vehicle fob 100 may further include a tailgate button 150 disposed on at least a portion of the main body 110 to open a tailgate of the at least one vehicle in response to being depressed a first time, and close the tailgate of the at least one vehicle in response to being depressed a second time.

The plurality of vehicle select buttons 120 may be programmable to connect to the at least one vehicle by holding a key of the at least one vehicle within a predetermined distance of the main body 110 and depressing at least one of the plurality of vehicle select buttons 120 for a predetermined period of time.

The plurality of vehicle select buttons 120 and the vehicle power button 130 may be semi-spherical and protrude a distance above a surface of the main body 110 to facilitate touching.

The plurality of vehicle select buttons 120 and the vehicle power button 130 may have textured indicia disposed thereon to identify at least one of a type of button and functionality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A multi-vehicle fob, comprising:
a main body;
a plurality of vehicle select buttons disposed on at least a portion of the main body, each of the plurality of vehicle select buttons to select at least one vehicle in response to being depressed; and
a vehicle power button disposed on at least a portion of the main body to turn on the at least one vehicle in response to being depressed a first time based on which vehicle is currently selected, and turn off the at least one vehicle in response to being depressed a second time.

2. The multi-vehicle fob of claim 1, wherein the vehicle power button turns on an alarm of the at least one vehicle in response to being depressed a first time for a first predetermined period of time, and turns off the alarm of the at least one vehicle in response to being depressed a second time for a second predetermined period of time.

3. The multi-vehicle fob of claim 1, further comprising:
a tailgate button disposed on at least a portion of the main body to open a tailgate of the at least one vehicle in response to being depressed a first time, and close the tailgate of the at least one vehicle in response to being depressed a second time.

4. The multi-vehicle fob of claim 1, wherein the plurality of vehicle select buttons are programmable to connect to the at least one vehicle by holding a key of the at least one vehicle within a predetermined distance of the main body and depressing at least one of the plurality of vehicle select buttons for a predetermined period of time.

5. The multi-vehicle fob of claim 1, wherein the plurality of vehicle select buttons and the vehicle power button are semi-spherical and protrude a distance above a surface of the main body to facilitate touching.

6. The multi-vehicle fob of claim 1, wherein the plurality of vehicle select buttons and the vehicle power button have textured indicia disposed thereon to identify at least one of a type of button and functionality.
